(19) United States
(12) Patent Application Publication
(10) Pub. No.: US 2021/0272119 A1
(43) Pub. Date: Sep. 2, 2021

(54) Determination of Custom Defined Based Charge Back for Multi-Cloud

(71) Applicant: Prashant S. Mishra, Bellevue, WA (US)

(72) Inventor: Prashant S. Mishra, Bellevue, WA (US)

(21) Appl. No.: 16/804,025

(22) Filed: Feb. 28, 2020

(51) Int. Cl. G06Q 20/40; G06Q 20/14; G06Q 20/16

(52) U.S. Cl. CPC G06Q 20/407; G06Q 20/16; G06Q 20/145

(57) ABSTRACT

The method includes an IT custom-defined chargeback system which makes service consumer and revenue producing business unites aware of the costs of IT. This custom defined chargeback model allows to control escalating cost, improve decision-making, align behavior with organizational goals and lead to effective use of it. Service consumer selects the cloud plans based on cloud pricing and requirement of resources. User consumes all these resources under the supervision of cloud brain. If consumer crosses threshold value of resources consumption or cost, an alerts messages sent to managers and they take appropriate decision so that cloud resources should get used efficiently. Threshold validation and cloud bill assessment plays as very important role which gives clear cut idea about cloud resources consumption by each team. Admin analyze the monthly cloud bills and generates team wise chargeback reports. Manager of each team receives chargeback report for his team, as per the report managers take appropriate decision to improve the effective utilization of cloud resources.

### TECHNICAL FIELD

The present discloser relates to field of cloud computing environment particularly cloud plans (Subscription & Pay-as-you-go), cloud resources consumption, threshold value monitoring with alerts if crosses threshold value for cloud resource consumption.

### BACKGROUND

This discloser relates to custom-defined chargeback system. Cloud plans based on pricing model has mentioned in this draft. Cloud plans based on pricing model allows user or organization to subscribe IT cloud services for specific period with available set price. Options mainly indicates services on monthly or annual basis.

In this draft two types of cloud plans have been mentioned. Subscription budget plans and pay-as-you-go plan. In Subscription plan user pays monthly rental and for pay-as-you-go daily cloud rental is deducted.

Different end users have different requirements for cloud services. These cloud services can be availed using different pricing models. This draft focuses on two different pricing models, one is pay-as-you-go model and second is subscription pricing model.

While talking about pricing scheme of cloud providers, the first thing is that service provider aims to maximize the profit and the customers are looking for higher quality of services with lower price.

### SUMMARY OF THE INVENTION

The purpose of the present discloser is to provide different cloud pricing plans. Enterprises selects cloud pricing plan for cloud resources. The selection of cloud pricing plans based on customer requirement and available funds.

There are many pricing models available on cloud. Here we are discussing two major clouds plans based on time period: Fixed and Dynamic. Fixed pricing model are also called as static pricing models due to stability of the price for long time.

Subscription plan is the fixed plan. In this plan, user pays for complete one bill cycle for cloud resources. However, this type of pricing mostly unfair with the customers because they can overpay or underpay for their requirement.

The feature of fixed pricing, billing will be fixed for specified duration (here for one month). When customer selects monthly plan. Customer pays for complete one month and may consume the cloud services for complete one month or not, which seems to be unfair from consumer point of view.

Dynamic pricing model are called as real time pricing. This pricing model are very flexible. Customer pays for short time duration. Pay-as-you-go pricing method is a dynamic pricing model. In Pay-as-you-go plan customer will pay for specific time usage of cloud resources for example customer will pay on basis of 24 hours.

The main advantage of pay-as-you-go plan is that there is no wastage of resources because user pays only for 24 hours rather than for long fixed time period for example one month.

In the market customer should have ability to compare their options (cloud bill plans) and choose the best one, while cloud providers show their cloud billing pricing model to consumer. Price is an important factor for the company which provides cloud services because it affects the organizations profit.

At end of cloud bill cycle, bills from different cloud providers will come to organization. Admin studies all the bills and generate team wise chargeback report. Based on this chargeback reports managers takes appropriate decision so that cloud resources should get used efficiently.

### BRIEF DESCRIPTION OF DRAWINGS

FIG. 1 is a flow chart of custom defined charge back model in cloud application;

FIG. 2 is a block diagram of custom defined charge back in cloud application;

FIG. 3 is a functional diagram of custom defined charge back in cloud application;

FIG. 4 is the table of example of custom defined chargeback in cloud application;

### DETAIL DESCRIPTION

The subject matter described here is related to the selection of cloud services with pricing plans, cloud services consumption, monitoring, alerts and analysis of cloud bills with chargeback reports.

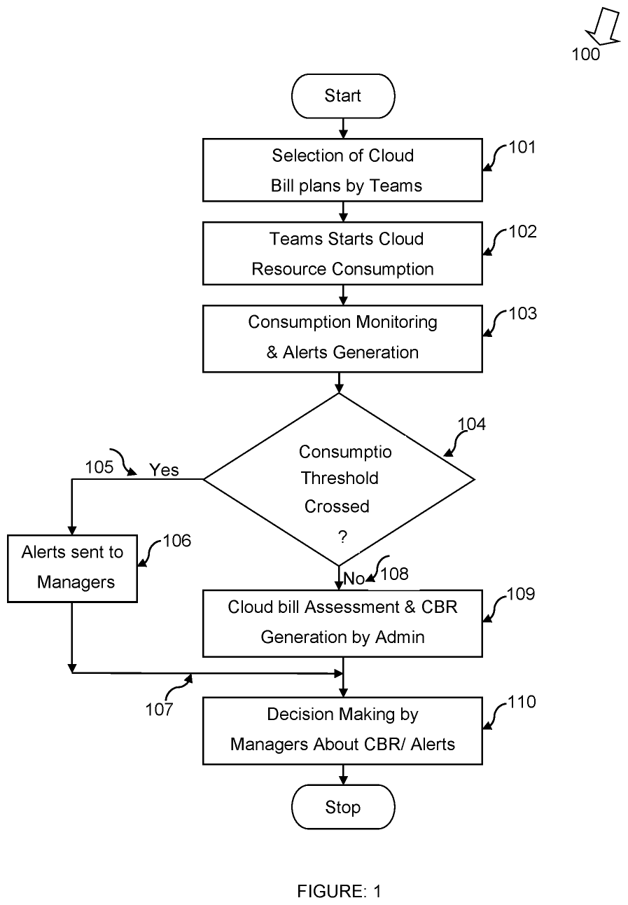

FIG. 1 is the flow chart of custom-based chargeback in cloud application. In system 100, different cloud plans will be selected by the teams 101 as per their requirement. One team can use multiple cloud plans. After selection of cloud plans teams will consume cloud resources 102.

During the process of consumption of cloud resources parallelly cloud brain will monitor the cost consumed by these resources 103. For each team their will, be the threshold value check 104 for cost model. If any team's consumption crosses 105 threshold value 104 an alert message 106 send to that respective managers 107.

If cloud resources consumption does not cross 108 the threshold value 104 then at end of the cloud bill cycle cloud bill sent to admin 109, admin analyze the cloud bill 108 and generate the team wise bill chargeback report. These chargeback reports sent to respective team managers 110.

On the basis consumption of cloud resources cloud bill will generated 109 and from the consolidated cloud bill chargeback report 109 will generated by admin of organization. Based on this chargeback report, respective team managers take appropriate decision 110 so that cloud resources should be use efficiently.

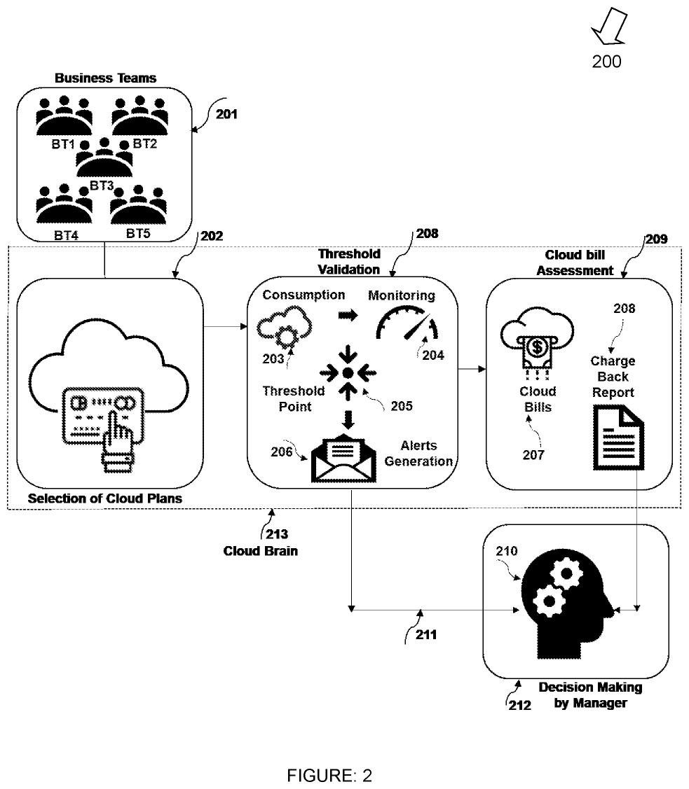

FIG. 2 is a block diagram of custom-based charge back system for multi-cloud. In system 200 business teams 201 selects different cloud plans 202 as per their requirements. After selection of cloud plans, user consumes 203 the cloud resources. Cloud resource consumption is monitored 204 by cloud brain continuously.

If the cloud resource consumption crosses the threshold value 205 alert message 206 will be sent to manager 211. After receiving the alert message, managers will take appropriate decision 210 so that cloud resources get efficiently used. He may give permission to continue the usage of cloud resources or may stop the consumption.

The complete unit of consumption, monitoring of cloud resources, threshold point monitoring and alert message to manager is comes under the threshold validation 208. If in threshold validation cloud resources consumption does not cross the threshold point, then at the end of monthly cloud cycle, cloud provider will send cloud bills 207 to admin. Admin will analyze all the cloud bills and generate the team wise chargeback report 208. Cloud bill assessment 209 is done by admin.

In cloud bill assessment, detailed analysis of cloud bill and generation of chargeback reports takes place. Team managers 210 will receive chargeback reports. As per the chargeback reports manager will take appropriate decision for his team so that cloud resources can be use efficiently.

Chargeback makes service consumers aware of the costs of IT and it is generally used to control escalating IT costs, to improve decision making, to align behavior with organizational goals, and to lead to a more effective use of IT resources.

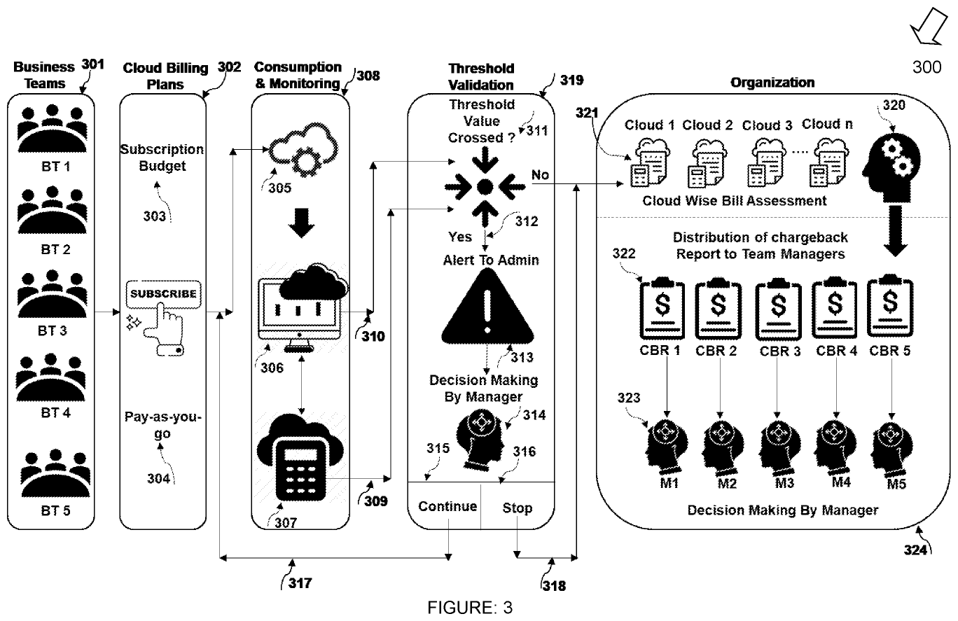

FIG. 3 shows the functional block diagram of custom-based chargeback in cloud environment. In the system 300 five business teams has shown namely BT 1, BT 2, BT 3, BT 4 and BT 5. Business teams will select cloud pricing plans 302. This selection of cloud pricing plans depends upon the requirement of the business teams' budget. In this draft two types of cloud pricing plans discussed namely subscription budget plan 303 plan and Pay-as-you-go plan 304.

In subscription budget plan 303, consumer will select the plan for complete one month. User subscribe cloud resources for complete one month. And bill will get pay at end of one month. Whereas in case of pay-as-you-go 304 user pays bills as per day cloud resource consumption basis.

Consumer consumes cloud resources 305 cloud brain monitors 308 the cloud resource consumption and expenses spent by business teams. Cloud brain keep monitoring of consumption of cloud resources 306 and cost spent 307 by business units.

If cloud resource consumption 306 or allotted cost 309 for particular team crosses 311 alerts sends to managers 313 of an organization. After receiving alert manager 314 will take appropriate decision. Managers may give permission to continue the usage of cloud resources 317 or may don't allow 318 to use cloud resources. If manager permits business team to use cloud resources, then business team will use cloud resources continuously 305.

If manager decides to stop 318 cloud resource consumption then till that date cloud bill will send to admin 320. Admin will study all the cloud bills 321 and then generates chargeback reposts 322 as per team. Each chargeback reports send to team managers 323. Respective team managers will study CBR and take appropriate decision so that cloud resources should get used efficiently.

If cloud resource consumption does not cross threshold value then at the end of month cloud bill 321 send to admin. Admin will study all cloud bills and generates the chargeback reposts 322. This chargeback reports will dispatch to managers 323. Manager will analyze chargeback reports and take appropriate decision to use cloud recourses efficiently.

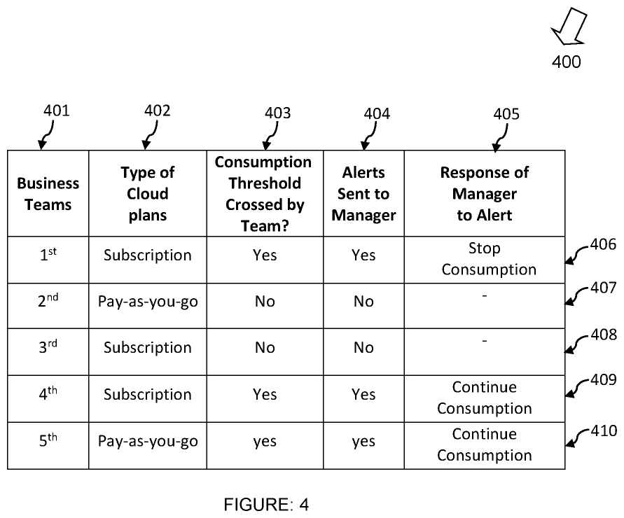

FIG. 4 is the table which shows different business teams 401, types of clouds plan 402, consumption threshold crossed by team 403, warning/alerts message to manager 404 response of manager to alert 405 for continue/stop consumption of cloud resources. In the given example 406, 1^{st} business team selected subscription cloud price plan and with regular consumption when team has crossed consumption threshold, then warning message has sent to respective managers. And managers took decision to stop the cloud resource consumption.

For 4^{th} and 5^{th} business teams 409,410 types of business plan selected is subscription plan and pay-as-you-go plan respectively. These teams crossed the consumption threshold as shown in table, so an alert sent to respective team managers, and accordingly they took decision to continue with cloud services consumption.

2^{nd} and 3^{rd} Business teams have selected pay-as-you-go plans 407 and 410. From the given entry it is clear that, these teams haven't crossed consumption threshold value. Therefore, no warning message sent to that respective team's manager.

Implementing custom defined chargeback models can leverage the cost advantages and business flexibility of the Cloud and further reduce IT costs. Business users get transparency regarding IT resources consumption due to chargeback report. In this invention very first thing is the selection of cloud plans. This depends on the size of the employees and their cloud resource usage and available finance.

1. A custom-based chargeback in cloud computing comprises of: Business units;
selection of cloud plans; threshold validation with monitoring of & consumption of cloud services; warnings/notification messages; cloud wise bill generation;
chargeback report generation; decision making by manager based on chargeback report.

2. The method of claim 1, wherein organization consists of business teams; each team select desired cloud services plans; that may be subscription budget plan or pay-as-you-go plan.

3. The method of claim 2, wherein business teams consumes cloud resources;
cloud brain monitors consumption of cloud resources or cost for threshold value;

4. The method of claim 2, wherein cloud resources or cost crosses threshold point, warning messages send to managers; managers take appropriate decision;
cloud resources utilization efficiently among the team members.

5. The method of claim 2, wherein cloud bill generats and admin analyses it and generate chargeback reposts for each team; manager will take appropriate decision based on chargeback and help the organization for efficient use of cloud resources.
